(19) United States
(12) Patent Application Publication
(10) Pub. No.: US 2004/0178969 A1
(43) Pub. Date: Sep. 16, 2004

(54) Spatial three-dimensional image display device

(76) Inventors: Kai Ming Zhang, Burnaby (CA); Zhao Hong Zhang, Burnaby (CA)

Correspondence Address: Kai Ming Zhang, 7974 17th Avenue, Burnaby, BC, V3N 1M3, CA

(21) Appl. No.: 10/384,831

(22) Filed: Mar. 11, 2003

(51) Int. Cl. H04N 13/04

(52) U.S. Cl. 345/6; 348/54

(57) ABSTRACT

A three-dimensional (3-D) display device, which continually moves the slits and shading barriers laterally (independent of the positions and movement of viewers) and displays the corresponding parallax images, which are designed and calculated according to the positions of the slits, that provides high resolution 3-D spatial graphics and animations with a wide viewing angle, so multiple viewers can see the regenerated 3-D image floating in space without wearing glasses and helmets.

### FIELD OF THE INVENTION

This invention relates to autostereoscopic displays, which can display high resolution 3-D images or animations with a wide viewing angle, and viewers can see the 3-D image without special glasses and helmets.

### BACKGROUND OF THE INVENTION

Three-dimensional (3-D) devices that do not need special glasses and helmets include systems such as integral photograph, parallax panoramagram, hologram and etc. The current invention is based on the second step in two-step integral photography. The second step in two-step integral photography converts the pseudoscopic image, which is an image inverted in its depth, to an orthoscopic image, which is an integral image with the correct depths, by retake a second integral photograph of the reconstructed image of the pseudoscopic image.

Takanori Okoshi in his book “Three-Dimensional Imaging Techniques” mentioned that A. P. Sokolov of Moscow University performed the first experiment with integral photography in 1911. Sokolov prepared a pinhole sheet provided with 1200 cone-shaped pinholes. The thickness and dimensions of the sheet were 3 mm and 150×200 mm². Such a pinhole sheet is equivalent to a fly's-eye lens sheet except for the brightness of the image obtained. He took a photo of incandescent lamp and obtained definite depth sensation.

In 1960s fly's-eye lens sheet, which is a glass or plastic sheet consisting of a tremendous number of small convex lenses was used to construct integral photograph. About 20 years later people created a simplified version of the integral photograph so-called lenticular-sheet 3-D pictures. The vertical parallax information is given up when a lenticular-sheet is used. Descriptions for improved versions of lenticular-sheet 3-D pictures such as systems that use head tracking devices to increase the viewing angle are omitted because they are not related to our invention.

As mention earlier, two-step integral photography overcomes the pesudoscopic image problem by retake an orthoscopic image from the reconstructed image. The orthoscopic image can be calculated and displayed on a monitor. A computer generated integral photograph can be constructed by just place a pinhole sheet in front of the calculated orthoscopic image. If only the horizontal parallax images are calculated and displayed, a slit plate can be used to reconstruct the 3-D image. This device has the following problems. The computer generated integral photograph provides very limited viewing angle and resolution. There is a contradiction between the viewing angle and the resolution. To increase the viewing angle, the resolution must be decreased and vice versa.

### SUMMARY OF THE INVENTION

The objective of the 3-D image displayed device is that the image displayed by the device is design by a person.

Another objective of the present invention is to provide a 3-D display device, which can generate a high resolution 3-D spatial image with a wide viewing angle. The spatial image here means a freely moving viewer within the viewing angle can see different portion of the 3-D image from different angle.

Another objective of the present invention is to let viewers see the generated 3-D image like looking at a real 3-D object, so they don't have to focus their eyes at a fixed distance to look at the 3-D image. Therefore, uncomfortable feelings arise from looking at binocular 3-D image can be eliminated.

Yet, another objective of the present invention is to produce 3-D spatial image animations. This animation can be used in a game environment where multiple viewers can play and cooperate or interact with each other physically.

To accomplish the above objectives the new display device includes a LCD screen A for displaying slits and shading barriers, a LCD screen B for displaying parallax images (like those from a integral photograph) according to the position of the slits, a synchronizing control system, which synchronized the refresh rate of the two LCD screens, and a light source which emits light from the back of LCD screen B. Screen A is synchronized with screen B means when one frame of slits are displayed, the corresponding parallax images must be displayed at the same time. When the slits are moved to the next position, the new corresponding parallax images must be display at the same time too.

The slits are moved from one side of the screen to the other and the corresponding parallax images are displayed according to the positions of the slits at a really high rate, then a high resolution 3-D image with a wide viewing angle can be displayed.

The 3-D spatial image generated here ignores the vertical parallax information. If the both the vertical and the horizontal parallax information is calculated and displayed on the image LCD, then barrier LCD which displays little transparent dots on it (same as a pinhole sheet built by A. P. Sokolov in 1911) can be used. The 3-D effect of a 3-D image, which contains only the horizontal parallax information, can only be observed when the viewer look at the image horizontally means there is no 3-D effect in the vertical direction. When both the horizontal parallax information and the vertical parallax information are displayed, the LCD must support an extremely high refresh rate, because to produce such a high resolution 3-D image with a wide viewing angle follows the same steps, which are the transparent dots must be moving and the parallax images must be recalculated each time according to the position of the dots, therefore, the new invention simplifies the calculation and display process by only calculate and display the horizontal information on a image LCD and displays slits and barriers instead of transparent dots on the barrier LCD.

### DESCRIPTION OF THE DRAWINGS

FIG. 1 shows the embodiments of the spatial three-dimensional display device

FIG. 2 shows the relationship between a designed object and the LCD screens

FIG. 3 shows the relationship between a viewer's eyes and a constructed 3-D image

FIG. 4 shows how the slits are moved on the barrier screen

### DETAILED DESCRIPTION OF THE EMBODIMENTS

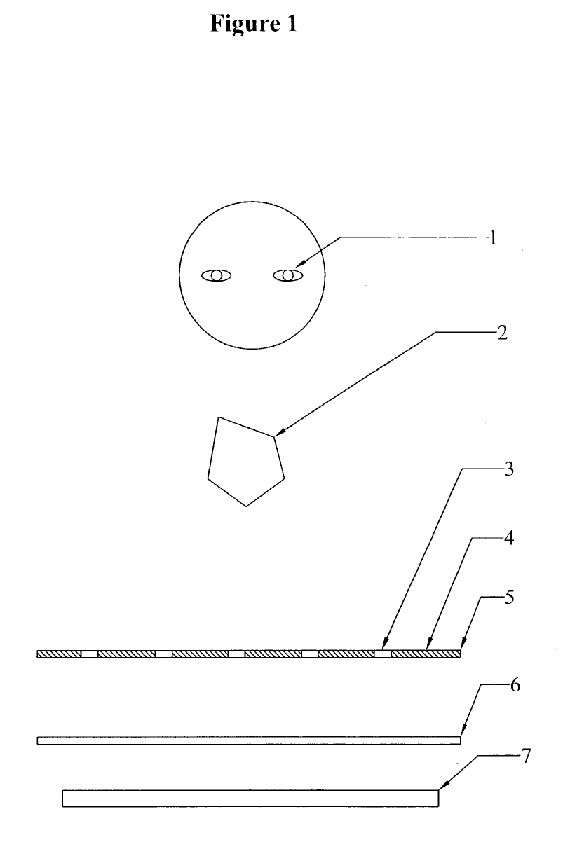

The following information is about the detail description of the new invention with reference to the drawings. FIG. 1 shows a viewer 1 looks at the 3-D image generated by the new 3-D image display device through the slits 3. The new device consists of two LCD screens 5 and 6. The barrier LCD 5 is a monochromatic screen or a color LCD screen. The image LCD 6 is a color screen. A computer generated 3-D image is displayed on LCD 6. The slits 3 and shading barriers 4 are displayed on LCD 5 (FIG. 1). The slits move laterally to either side of the screen. The movements of the slits means turn on and off the barriers to laterally move the slits. The LCD 5 is synchronized with LCD 6. Each time the slits are moved, the corresponding 3-D horizontal parallax images are calculated and displayed on LCD 6. When the slits at the position shown in FIG. 1, the corresponding computer generated 3-D image is displayed on LCD 6. A light source 7 is projected to LCD 6 at the back of LCD 6, such that a 3-D image 2 floating in space is constructed.

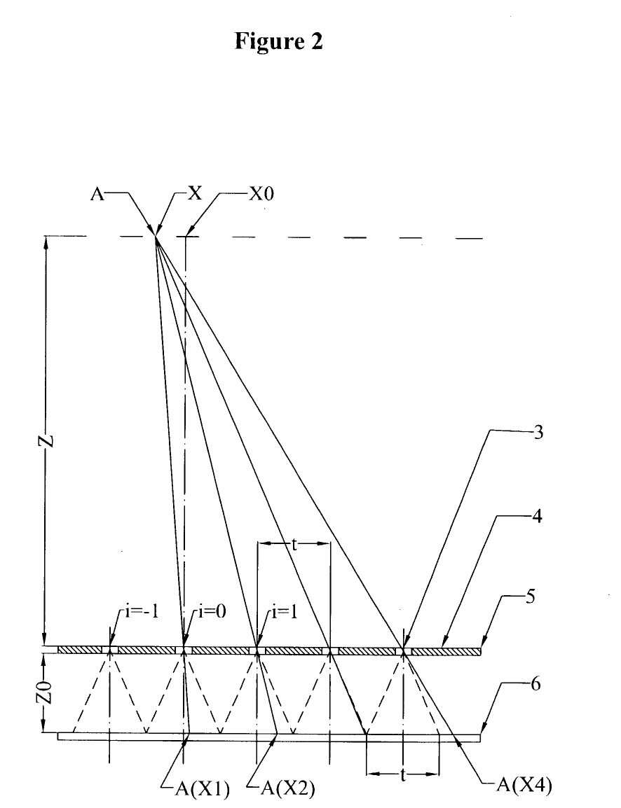

Because the new device uses slits and shading barriers, only the horizontal parallax images are calculated. The parallax image calculation of a single point in space is shown as follows. In FIG. 2 an object A (a single point in space) is set. The function for regenerating its horizontal parallax image is shown as follows

$$Xi = ( i \times t + ( X - X0 ) ) \times \frac{Z + Z0}{Z} + X$$

i: slit number

t: the pitch between two slits next to each other

X: the horizontal coordinate of the object A

X0: horizontal coordinate of the slit that is the closest to X

Z: the distance between the object A and the LCD 5

Z0: the distance between the LCD 5 and the LCD 6

Xi: the calculated pixel on the LCD 6 corresponding to the slit number i

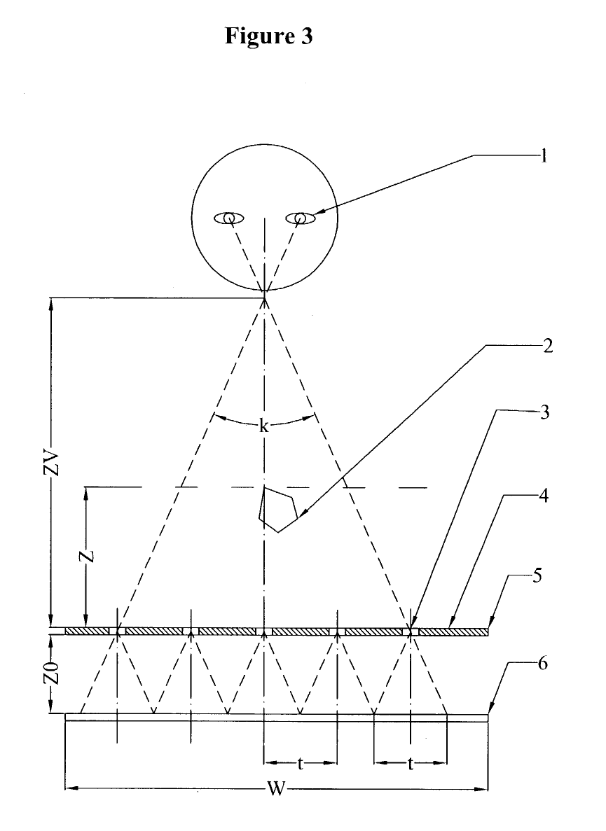

A large object can be represented by a number of sample points. By calculating all the points, the horizontal parallax information of the object can be constructed. If the parallax images are just displayed on the screen, there could be an overlapping area. To avoid this problem, the LCD 6 screen is separated into small regions (a number of pixels) according to the slits. A(X1) and A(X2) are within preset regions. If the parallax image calculated exceeds its own region, the exceeding portion A(X4) (FIG. 2) of the image is omitted. The viewing angle is limited when the LCD screen is separated into regions. See FIG. 3, W is the width of the LCD screen, t is the width of one region set according to a slit and k is the viewing angle.

$$tg ( \frac{k}{2} ) = \frac{t}{2 \times Z0}$$

The following function, which is used to calculate the minimum viewing distance ZV (FIG. 3)

$$\frac{ZV}{W} = \frac{Z0}{t}$$

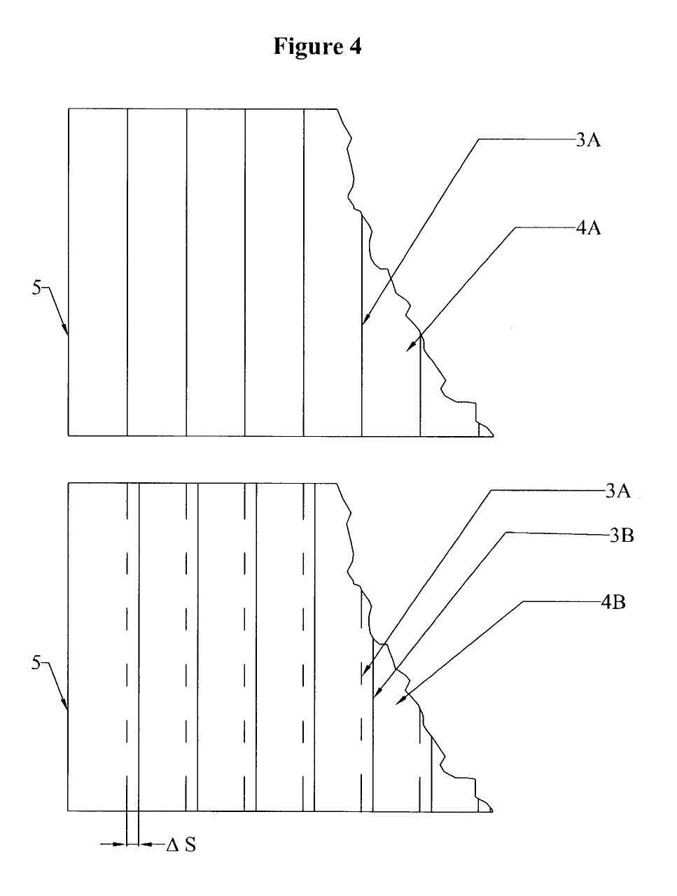

The number of slits is set according to the viewing angle and the width (in pixels) of the LCD screen 6. The width W of the LCD screen 6 divided by the number of slits is the pitch t between two slits next to each other. The slits are moved by a distance of AS laterally from one side of the LCD screen 5 to the other and the corresponding calculated parallax images are displayed each time. FIG. 4 shows how the slits move on LCD screen 5. 3A and 4A are the previous positions of the slits and shading barriers. 3B and 4B are the new positions of the slits and shading barriers. The slits must be moved N (N=W/S) number of times to fill the whole LCD screen 5. When ΔS becomes smaller and smaller, the resolution of the 3-D image increases. The resolution reaches it maximum when ΔS equals to the distance between two pixels, which are next to each other in the horizontal direction on the LCD screen 5.

The calculation of the pitch t between two slits next to each other and the resolution for one frame of the 3-D image is shown as follows:

Let

k=65°

Z0=20 mm

W=500 min

$$\begin{matrix}\begin{matrix} tg ( \frac{{65}^{°}}{2} ) = \frac{t}{2 \times 20 mm} \\ t \approx 25 mm \end{matrix} \\ \frac{500 mm}{25 mm \text{/} slit} 20 slits\end{matrix}$$

With the above information and results W=500 mm, Z0=20 mm, and t=25 mm the value of zv can be obtained.

$$\begin{matrix}\frac{ZV}{500 mm} = \frac{20 mm}{25 mm} \\ ZV = 400 mm \end{matrix}$$

The distance between the viewer and LCD screen 5 must be bigger than ZV, so he/she can see the 3-D image.

There are 20 slits on the LCD screen 5. The pitch t between two slits next to each other is 32 pixels when the horizontal resolution of the LCD screen 5 is 640 pixels. FIG. 4 shows the arrangement of a portion of the slits on the LCD screen 5. The set here is defined as the slits are moved by ΔS number of pixel at a time on LCD screen 5 and the corresponding parallax images are calculated and displayed on LCD screen 6. To fill the whole screen there should be 32 sets since the pitch of the shading barrier is 32 pixels. When these 32 sets are continually displayed at a rate of 320 sets per second, a spatial 3-D image with a resolution of 640 slits and a viewing angle of 65° can be observed. A freely moving viewer with two eyes can see the 3-D regenerated 3-D image floating in space where the object designed. The above statement holds not only for the specific point but for all points upon the entire object. This means that different views at different location within the viewing angle can see different portions of the 3-D object. If the sets are calculated and displayed according to a moving object, an animated 3-D spatial image can be observed. These images with true colors are just like images produced using 3-D graphics programs except they are spatial images that have real depths. When the display rate increases (sets displayed per second), the resolution of the generated 3-D image increases.

A transparent substance such as plastic or glass can be used to produce a barrier with slits to replace LCD screen 5 By moving such barrier laterally in front of LCD 6, it gives the same result as LCD screen 5 does.

We claim:

1. A spatial 3-D image display device comprising:
An image display means for displaying 3-D parallax images.
A slit barrier.
A synchronized system for synchronizing the refresh rates between the image display and the barrier display.
A light source emits light behind the image display.
A computer, which calculates the parallax images and displays the images on the image display, and displays shading barriers and slits on the barrier display.
Slits movement means for laterally and continually moving the slits and barriers from one side of the image display to the other.

2. The spatial 3-D image display device defined in claim 1 in which the image display is placed behind the slit barrier.

3. The spatial 3-D image display device defined in claim 1 in which the light source in placed behind the image display.

4. The spatial 3-D image display device defined in claim 1 in which the image display can be a Liquid Crystal Display (LCD), a Cathode Ray Tube, or a Plasma display.

5. The spatial 3-D image display device defined in claim 1 in which the slit barrier can be a color or black and white LCD, which displays slits and barriers, or an object in slits and barriers form.

6. The spatial 3-D image display device defined in claim 1 in which the pitch of the slits and pitch the shading barriers can be changed.

7. The spatial 3-D image display device defined in claim 1 where the slits are vertical transparent lines with a height of one or more image displays.

8. The spatial 3-D image display device defined in claim 1 in which the slits movement means to move the slits step by step and each step equal to one or more of the image display pixels.

9. The spatial 3-D image display device defined in claim 1 in which the slits movement is independent of viewers' positions and movements.

10. The spatial 3-D image display device according to claim 1, wherein the synchronization between the image display and the barrier display means when the slits move, the corresponding parallax images must be calculated and displayed on the image display at the exact same time.

11. The spatial 3-D image display device defined in claim 10 in which the corresponding parallax image means the parallax images are calculated based on the positions of the slits.

12. The spatial 3-D image display device according to claim 10, wherein said the corresponding parallax images are constructed in the following steps:
a. Design a 3-D object in space
b. Get the sample points from the designed 3-D object and use a computer to calculate the parallax images of the points.
c. Display the points on an image display.

13. The spatial 3-D image display device defined in claim 1 in which the light source projects the parallax images from the image display though the slits, which are on the barrier display, such that a 3-D image in space is constructed.

14. The spatial 3-D image display device of claim 1 can construct 3-D spatial images, which are similar to the integral photograph, but with a wide viewing angle and a high resolution.

15. The spatial 3-D image display device defined in claim 10 in which the spatial 3-D image can contain different colors from back and white to true colors.
